(19) United States
(12) Patent Application Publication
(10) Pub. No.: US 2020/0363574 A1
(43) Pub. Date: Nov. 19, 2020

(54) DIFFRACTIVE OPTICAL ELEMENT AND OPTICAL DEVICE COMPRISING SAME DIFFRACTIVE OPTICAL ELEMENT

(71) Applicant: ZHUHAI MULTISCALE PHOTOELECTRIC TECHNOLOGY CO., LTD, ZHUHAI (CN)

(72) Inventors: CHUNLEI DU, ZHUHAI (CN); LIANGPING XIA, ZHUHAI (CN)

(21) Appl. No.: 16/768,071

(22) PCT Filed: Feb. 9, 2018
(86) PCT No.: PCT/CN2018/075934

§ 371 Date: May 28, 2020

(30) Foreign Application Priority Data
Dec. 29, 2017 (CN) 201711473403.8

(51) Int. Cl. G02B 5/18

(52) U.S. Cl. CPC G02B 5/1866; G02B 2005/1804

(57) ABSTRACT

Provided is a diffractive optical element having an optical surface composed of a plurality of continuous three-dimensional curved surface units. When a parallel coherent light is incident on the optical surface, a diffraction pattern formed by multiple diffraction orders is produced, thereby expands the divergence angle of the diffractive optical element. Further provided is an optical device including the above diffractive optical element.

### TECHNICAL FIELD

The present disclosure relates to an optical device, and more particularly relates to a diffractive optical element and an optical device comprising the same diffractive optical element.

### BACKGROUND

Diffractive optical elements (DOE's) are used extensively in beam shaping, beam splitting, and special optical pattern generation. They can be applied to fields including three-dimensional measurement, laser radar, optical communications, stage display, and so on.

Current diffractive optical elements have an optical surface that typically comes in a stepped shape. By scribing two-dimensional gratings of different discrete steps on an optical plane, discrete two-dimensional gratings of different depths would produce different phase modulations, thereby generating a diffraction pattern in the far field.

However, limited by the existing design method, with such a stepped shape diffraction device almost only the first order diffraction can be utilized, and since the divergence angle of a stepped shape diffractive optics is determined by its feature size, an extremely small feature size is therefore required to obtain a large-angle diffraction pattern. This not only requires high-level device processing conditions, but significantly constrains the applications of the diffractive optical element for the intensity of zero-order diffracted light is very sensitive to errors in the step depth and the incident light wavelength, thus any subtle depth errors or wavelength shifts would introduce strong central zero-order diffraction and cause the failure of the DOE.

### SUMMARY

In view of the above, there is a need to provide a diffractive optical element aimed at solving the application limitations of the stepped type diffractive optical devices provided in the related art.

In order to achieve the above object, the present disclosure adopts the following technical solutions.

In one aspect, the present disclosure provides a diffractive optical element having an optical surface comprised of a plurality of continuous three-dimensional curved surface units.

In some typical embodiments, the material of each of the three-dimensional curved surface units is an optical plastic or optical glass.

In some typical embodiments, each of the three-dimensional curved surface units includes any one of a three-dimensional convex curved surface, a three-dimensional concave curved surface, and a three-dimensional wavy curved surface.

In some typical embodiments, convex heights of the three-dimensional convex curved surfaces are equal.

In some typical embodiments, concave heights of the three-dimensional concave curved surfaces are equal.

In some typical embodiments, a convex height of any one of the three-dimensional convex curved surfaces is equal to a concave height of any one of the three-dimensional concave curved surfaces.

In some typical embodiments, heights of a peak and a trough of the three-dimensional wavy surfaces are equal.

In some typical embodiments, heights of a peak and a trough of the three-dimensional wavy surfaces are equal.

In some typical embodiments, when a laser is incident on the optical surface of the diffractive optical device, a large-angle diffraction pattern formed by multi-order diffraction is generated in the far field, and the central zero-order spot has an energy that is equivalent to that of the adjacent order.

In another aspect, the present disclosure further provides an optical device comprising the diffractive optical element disclosed above.

Adopting the above technical solutions, the present disclosure can achieve the following beneficial effects.

In the diffractive optical element provided by the present disclosure, the optical surface of the diffractive optical element is composed of a plurality of continuous three-dimensional curved surface units. When a parallel coherent light is incident on the optical surface, a diffraction pattern formed by multiple diffraction orders is produced, thereby expands the divergence angle of the diffractive optical device.

With the diffractive optical element provided by the present disclosure. the diffraction pattern produced by the parallel coherent light incident on its optical surface is insensitive to the depth of the three-dimensional continuous surface, therefore it avoids the central zero-order bright spot caused by the depth error in the stepped type diffraction device, leading to a wider applicable range of the diffractive optical element.

### BRIEF DESCRIPTION OF DRAWINGS

FIG. 1 is a cross-sectional view of a diffractive optical element provided in a first embodiment according to the present disclosure.

FIG. 2 is schematic diagram illustrating the distribution of a plurality of continuous three-dimensional curved surface units provided in the first embodiment.

FIG. 3 is a cross-sectional view of a diffractive optical element provided in a second embodiment according to the present disclosure.

FIG. 4 is schematic diagram illustrating the distribution of a plurality of continuous three-dimensional curved surface units provided in the second embodiment.

FIG. 5 is a cross-sectional view of a diffractive optical element provided in a third embodiment according to the present disclosure.

FIG. 6 is schematic diagram illustrating the distribution of a plurality of continuous three-dimensional curved surface units provided in the third embodiment.

### DETAILED DESCRIPTION

For a better understanding of the objects, technical solutions and advantages of the present disclosure, a detailed description of the present disclosure is provided below in connection with the accompanying drawings and embodiments. It is to be understood that the specific embodiments described herein are merely illustrative of the present disclosure and are not intended to limit the present disclosure.

The present disclosure provides a diffractive optical element having an optical surface composed of a plurality of continuous three-dimensional curved surface units.

In some typical embodiments, the three-dimensional curved surface units employ a minute structure to reduce the feature size of the three-dimensional continuous curved surface structure.

In some typical embodiments, the order of magnitude of the minute structures lies between submicron and hundred-micron dimensions.

In some typical embodiments, the material of each of the three-dimensional curved surface units is an optical plastic or optical glass.

In some typical embodiments, each of the three-dimensional curved surface units includes any one of a three-dimensional convex curved surface, a three-dimensional concave curved surface, and a three-dimensional wavy curved surface.

It can be understood that each one of the three-dimensional curved surface units will not be limited to the above three shapes or to the combinations of the above three shapes, and other irregular curved surface shapes may he used in practice.

In some typical embodiments, the convex heights of any of the three-dimensional con vex curved surfaces are equal, and/or the concave heights of any of the three-dimensional concave curved surfaces are equal, and/or the convex height of any one of the three-dimensional convex curved surfaces is equal to the concave height of any one of the three-dimensional concave curved surfaces, and/or the heights of the peaks and troughs of any one of the three-dimensional wavy curved surfaces are equal.

In some typical embodiments, when a parallel coherent light is incident on the optical surface of the diffractive optical device, a large-angle diffraction pattern formed by multi-order diffraction is generated in the far field, and the central zero-order spot has an energy equivalent to that of the adjacent order. It can be understood that when a parallel coherent light is incident on the optical surface of the diffractive optical element, multi-order diffraction would occur in the far field, and since the energy difference between different diffraction orders is small, a large-angle diffraction pattern can be formed, and the central zero-order spot would have an energy that is comparable to the adjacent order. In one aspect, the optical surface of the diffractive optical element provided by the present disclosure is composed of a plurality of continuous three-dimensional curved surface units, and when a parallel coherent light is incident on the optical surface a diffraction pattern composed of a plurality of diffraction orders would be generated, thereby increasing the angle of the diffractive optical device.

In another aspect, with the diffractive optical element provided by the present disclosure, the diffraction pattern produced by the parallel coherent light incident on its optical surface is insensitive to the depth of the three-dimensional continuous surface, avoiding the central zero-order bright spot caused by the depth error in the stepped type diffraction device, leading to an even wider applicable range of the diffractive optical element.

In addition, the present disclosure further provides an optical device comprising the above-described diffractive optical element.

The specific implementation of the present disclosure is described in detail below in conjunction with specific embodiments.

### Embodiment 1

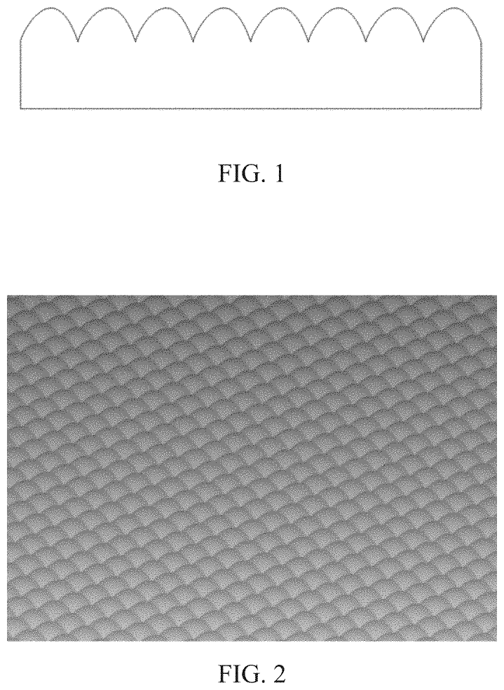

Referring to FIG. 1, there is shown a cross-sectional view of a diffractive optical element provided in a first embodiment according to the present disclosure.

In this embodiment, the optical surface of the diffractive optical element is composed of continuous three-dimensional curved surface units. Each of the three-dimensional curved surface units is composed of a three-dimensional convex curved surface. The material of the three-dimensional convex curved surface is optical plastic (PC). And each three-dimensional convex curved surface has a dimension of 4 microns and a height of 1.8 microns.

Turning now to FIG. 2, which is schematic diagram illustrating the distribution of a plurality of continuous three-dimensional curved surface units provided in the first embodiment.

In this embodiment, the three-dimensional curved surface units are arranged in closely fitting quadrangular shapes.

The far-field diffraction pattern produced by the parallel coherent light incident on the three-dimensional curved surface units is a quadrilateral point type beam splitter.

At a wavelength of 650 nm, the diffraction angle of each order is 9.35°, and there are a total of 6 clearly visible diffraction orders; that is, the resulting beam splitter is 13*13, and the central zero-order light intensity is equivalent to ±1 level.

At a wavelength of 940 nm, the diffraction angle of each order is 13.5°, and there are a total of 4 clearly visible diffraction orders; that is, the resulting beam splitter is 9*9, and the central zero-order light intensity is equivalent to +1 level.

### Embodiment 2

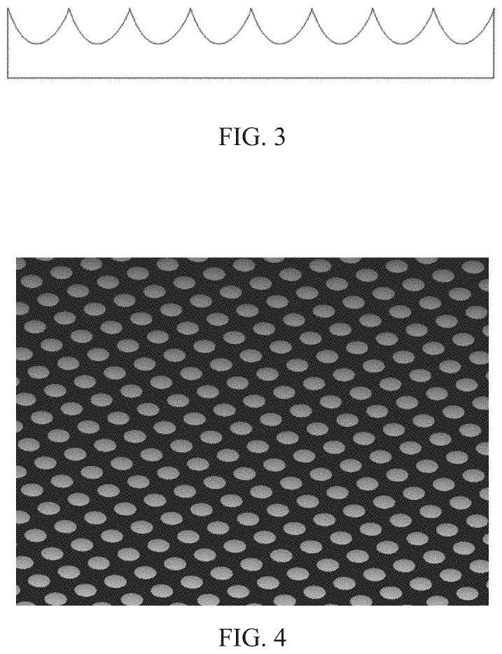

Referring now to FIG. 3, there is shown a cross-sectional view of a diffractive optical element provided in a second embodiment according to the present disclosure.

In this embodiment, the optical surface of the diffractive optical element is composed of continuous three-dimensional curved surface units. Each of the three-dimensional curved surface units is composed of a three-dimensional concave curved surface. The material of the three-dimensional concave curved surface is optical glass (D-ZK3), and each three-dimensional concave curved surface has a dimension of 5 micrometers and a height of 1 micrometer.

Turning now to FIG. 4, which is schematic diagram illustrating the distribution of a plurality of continuous three-dimensional curved surface units provided in second embodiment.

In this embodiment, the three-dimensional curved surface units are sparsely arranged in quadrangular shapes.

The far-field diffraction pattern produced by the parallel coherent light incident on the three-dimensional curved surface units is a quadrilateral point type beam splitter.

At a wavelength of 650 nm, the diffraction angle of each order is 7°, and there are a total of 7 clearly visible diffraction orders; that is, the resulting beam splitter is 15*15, and the central zero-order light intensity is equivalent to ±1 level. At a wavelength of 940 nm, the diffraction angle of each order is 10.1°, and there are a total of 5 clearly visible diffraction orders; that is, the resulting beam splitter is 11*11, and the central zero-order light intensity is equivalent to ±1 level.

### Embodiment 3

Referring now to FIG. 5, there is shown a cross-sectional view of a diffractive optical element provided in a third embodiment according to the present disclosure.

In this embodiment, the optical surface of the diffractive optical element is composed of continuous three-dimensional curved surface units. Each of the three-dimensional curved surface units is composed of a three-dimensional wavy curved surface. The material of the three-dimensional wavy curved surface is optical glass (quartz), and each three-dimensional wavy curved surface has a dimension of 3 micrometers and a height of 1.5 micrometer (referring to the height of the peak or trough).

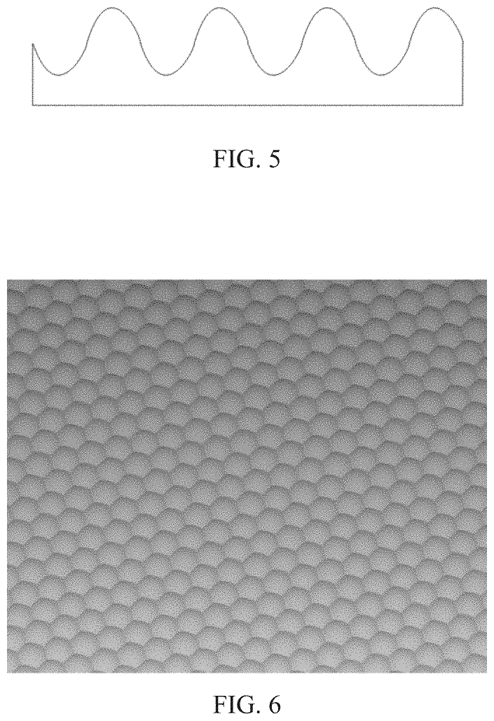

Turning now to FIG. 6, which is schematic diagram illustrating the distribution of a plurality of continuous three-dimensional curved surface units provided in the third embodiment.

In this embodiment, the three-dimensional curved surface units are sparsely arranged in hexagonal shapes.

The far-field diffraction pattern produced by the parallel coherent light incident on the three-dimensional curved surface units is a hexagonal point type beam splitter.

At a wavelength of 532 nm, the diffraction angle of each order is 10.2°, and there are a total of 6 clearly visible diffraction orders, and the central zero-order light intensity is equivalent to ±1 level. And at a wavelength of 830 nm, the diffraction angle of each order is 16°, and there are a total of 3 clearly visible diffraction orders, and the central zero-order light intensity is equivalent to +1 level.

The foregoing merely portrays some illustrative embodiments of the present disclosure, and is not intended to limit the present disclosure in any form. Any modifications, equivalent substitutions and improvements made within the spirit and scope of the present disclosure are intended to be included within the scope of protection of the present disclosure.

1. A diffractive optical element, comprising an optical surface comprised of a plurality of continuous three-dimensional curved surface units.

2. The diffractive optical element as recited in claim 1, wherein each of the three-dimensional curved surface units has a material comprising an optical plastic or an optical glass,

3. The diffractive optical element as recited in claim 1, wherein each of the three-dimensional curved surface units comprises one selected from the group consisting of a three-dimensional convex curved surface, a three-dimensional concave curved surface, and a three-dimensional wavy curved surface.

4. The diffractive optical element as recited in claim 3, wherein the three-dimensional convex curved surfaces have equal convex heights.

5. The diffractive optical element as recited in claim 3, wherein the three-dimensional concave curved surfaces have equal concave heights.

6. The diffractive optical element as recited in claim 3, wherein a convex height of each of the three-dimensional convex curved surfaces is equal to a concave height of each of the three-dimensional concave curved surfaces.

7. The diffractive optical element as recited in claim 3, wherein heights of a peak and valley of each of the three-dimensional wavy curved surfaces are equal to those of the peak and valley of one another of the three-dimensional wavy curved surfaces.

8. (canceled)

9. The diffractive optical element as recited in claim 1, wherein in response to a laser being incident on the optical surface of the diffractive optical element, a large-angle diffraction pattern formed by multi-order diffraction is generated in a far field, and a central zero-order light spot has an energy equivalent to that of an adjacent order.

10. An optical device comprising the diffractive optical element, wherein the diffractive optical element comprises an optical surface comprised of a plurality of continuous three-dimensional curved surface units.

11. The optical device as recited in claim 10, wherein each of the three-dimensional curved surface units has a material comprising an optical plastic or an optical glass.

12. The optical device as recited in claim 10, wherein each of the three-dimensional curved surface units comprises one selected from the group consisting of a three-dimensional convex curved surface, a three-dimensional concave curved surface, and a three-dimensional wavy curved surface.

13. The optical device as recited in claim 12, wherein the three-dimensional convex curved surfaces have equal convex heights.

14. The optical device as recited in claim 12, wherein the three-dimensional concave curved surfaces have equal concave heights.

15. The optical device as recited in claim 12, wherein a convex height of each of the three-dimensional convex curved surfaces is equal to a concave height of each of the three-dimensional concave curved surfaces.

16. The optical device as recited in claim 12, wherein heights of a peak and valley of each of the three-dimensional wavy curved surfaces are equal to those of the peak and valley of one another of the three-dimensional wavy curved surfaces.

17. The optical device as recited in claim 10, wherein in response to a laser being incident on the optical surface of the diffractive optical element, a large-angle diffraction pattern formed by multi-order diffraction is generated in a far field, and a central zero-order light spot has an energy equivalent to that of an adjacent order.
